(19) United States
(12) Patent Application Publication
(10) Pub. No.: US 2025/0352414 A1
(43) Pub. Date: Nov. 20, 2025

(54) BED

(71) Applicant: Correctional Technologies, Inc., Willowbrook, IL (US)

(72) Inventor: Joseph R. Claffy, Western Springs, IL (US)

(21) Appl. No.: 19/212,961

(22) Filed: May 20, 2025

Related U.S. Application Data
(60) Provisional application No. 63/649,678, filed on May 20, 2024.

(51) Int. Cl. A61G 7/05

(52) U.S. Cl. CPC A61G 7/0513; A61G 7/052

(57) ABSTRACT

In one aspect, a bed including a rotationally molded body. The body has a unitary, one-piece construction. The body includes a bed pan for receiving a mattress. The body further includes safety rail portions of the body on opposite sides of the bed pan. The safety rail portions are configured to extend above the mattress received on the bedpan and inhibit a user from falling out of the bed.

### CROSS-REFERENCE TO RELATED APPLICATION(S)

This application claims the benefit of U.S. Provisional Application No. 63/649,678 filed May 20, 2024, which is incorporated herein by reference in its entirety.

### TECHNICAL FIELD

This disclosure relates to furniture for correctional and mental health facilities and, more specifically, relates to beds for correctional, mental health, and behavioral health facilities.

### BACKGROUND

Correctional, mental health, and behavioral health facilities often have medical treatment departments for treating injuries or sickness. These hospitals and medical treatment departments typically utilize standard hospital beds that have metal railings to keep users, e.g., patients from falling off of the bed. In these environments, however, a metal railing may be removed by a patient and used as a weapon to hurt themselves or others.

### BRIEF DESCRIPTION OF DRAWINGS

FIG. 1 is a perspective view of a bed having safety rail portions on either side thereof to keep a patient from falling off of the bed;

FIG. 2 is a side elevational view of the bed of FIG. 1 showing one of the safety rail portions extending upward beyond a mattress of the bed;

FIG. 3 is an end elevational view of the bed of FIG. 1 showing the safety rail portions extending upward farther than a headboard portion and a footboard portion of the bed;

FIG. 4 is an end elevational view of the bed of FIG. 1 showing the safety rail portions extending above the headboard portion;

FIG. 5 is a plan view of the bed of FIG. 1 showing the safety rail portions and headboard portion forming a U-shaped receptacle for a pillow and a patient's head and shoulders to keep the patient on the bed;

FIG. 6 is a cross-sectional view taken along line 6-6 in FIG. 2 showing a hollow interior of one of the safety rail portions;

FIG. 7 is a cross-sectional view taken along line 7-7 in FIG. 2 showing a recessed and corrugated outer wall portion of one of the safety rail portions that strengthens the safety rail portion;

FIG. 8 is a bottom plan view of the bed of FIG. 1 showing compartments of an underside of the bed;

FIG. 9 is a cross-sectional view taken along line 9-9 in FIG. 5 showing one of the internal compartments of the bed;

FIG. 10 is a cross-sectional view taken along line 10-10 in FIG. 1 showing an anchor securing the bed to a floor;

FIGS. 11 and 12 are a series of cross-sectional views showing a process of forming an opening in a mounting flange that receives an anchor to secure the mounting flange to the floor.

### DETAILED DESCRIPTION

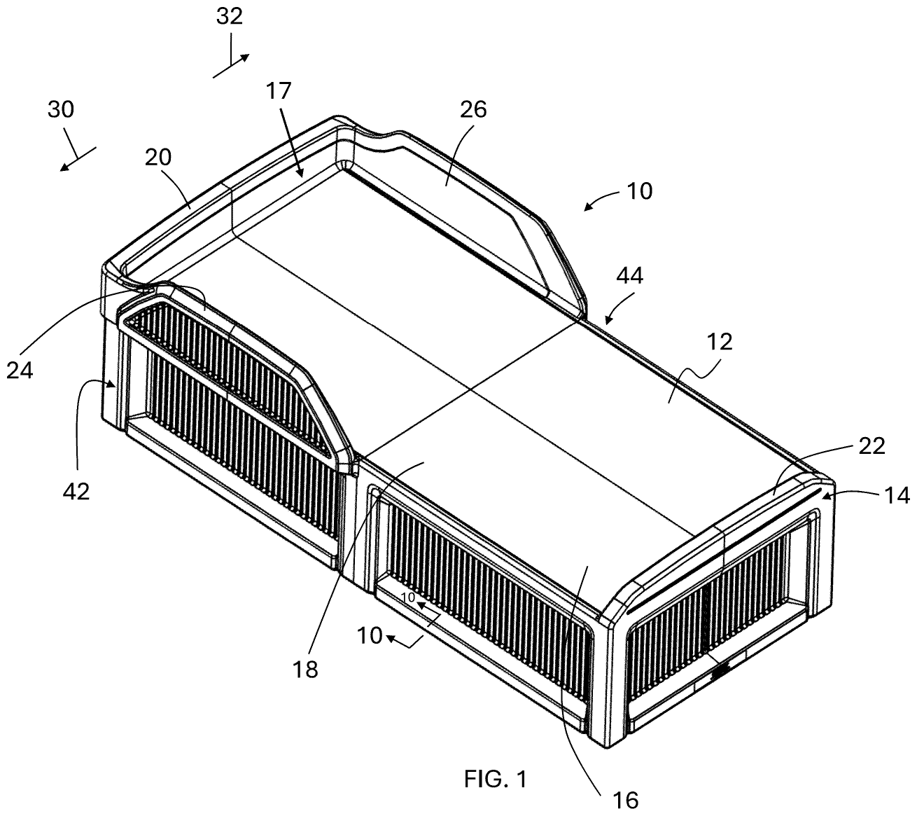

Regarding FIG. 1, a bed 10 is provided that has a body 12 formed using rotational molding and has a unitary, one-piece design. In one embodiment, the body 12 is rotationally molded with high-impact polyethylene. The body 12 is hollow and, in one embodiment, may contain a structural foam. The body 12 has exposed outer surfaces 14 that are ligature resistant. More specifically, the outer surfaces 14 of the bed 10 accessible by a patient lack sharp corners, sharp edges, through openings, or posts that a patient could use to injure themselves with. For example, the outer surfaces 14 lack features that a cord, rope, or other material can be tied around or leveraged by a patient to injure themselves.

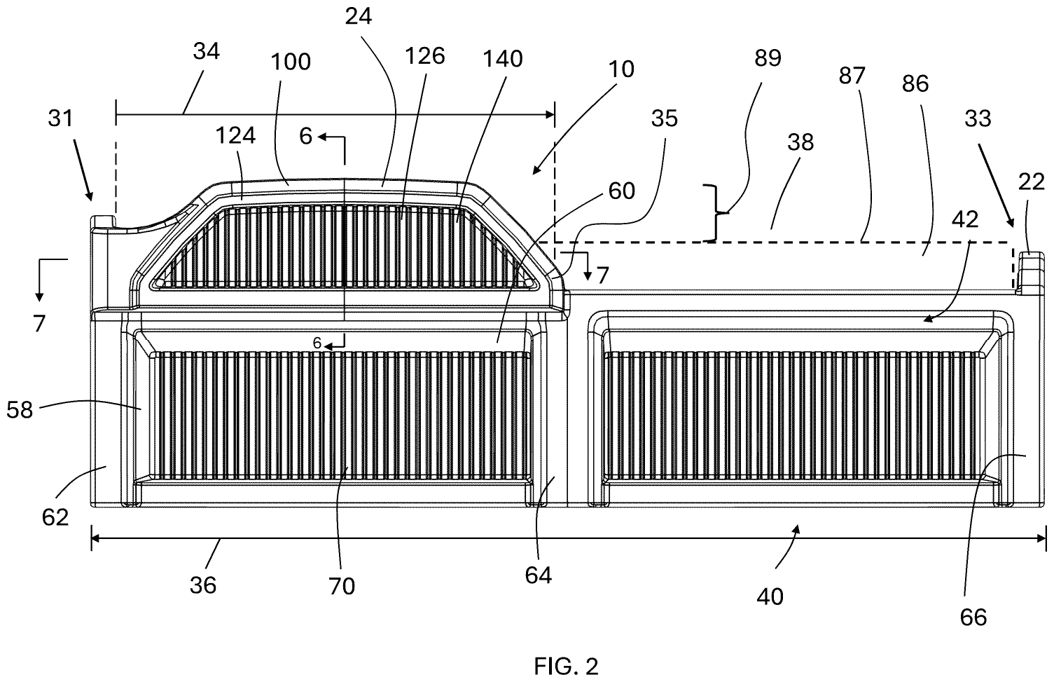

The bed 10 has a mattress support portion 16 with a bedpan 17 including an upper surface 18 to support a mattress 86 (see FIG. 2), a headboard portion 20, a footboard portion 22, and safety rail portions 24, 26 on opposite sides of the upper surface 18. The safety rail portions 24, 26 and headboard portion 20 are upstanding from an upper surface 87 (see FIG. 2) of the mattress 86 to restrict a patient from rolling off of the bed in directions 30, 32 (see FIG. 1). However, the safety rail portions 24, 26 extend a distance 34 that is less than a longitudinal length 36 of the bed 10 to provide lateral openings 38 between the safety rail portions 24, 26 and the footboard portion 22 that facilitates ingress and egress of a patient relative to the bed 10. Stated differently, the bed body 12 has a head end portion 31 and foot end portion 33. The safety rail portions 24, 26 each have an end 35 spaced longitudinally from the foot end portion 33 to form one of the lateral openings 38.

The bedpan 17 and safety rail portions 24, 26 have a unitary, one-piece construction. In the embodiment where the body 12 is rotationally molded, the bedpan 17 and safety rail portions 24, 26 are molded together. The safety rail portions 24, 26 are thereby fixed against movement relative to the bedpan 17. A patient is unable to remove the safety rail portions 24, 26 or otherwise disconnect the safety rail portions 24, 26 from the bedpan 17 due to the unitary, one-piece construction of the bed pan 17 with the safety rail portions 24, 26.

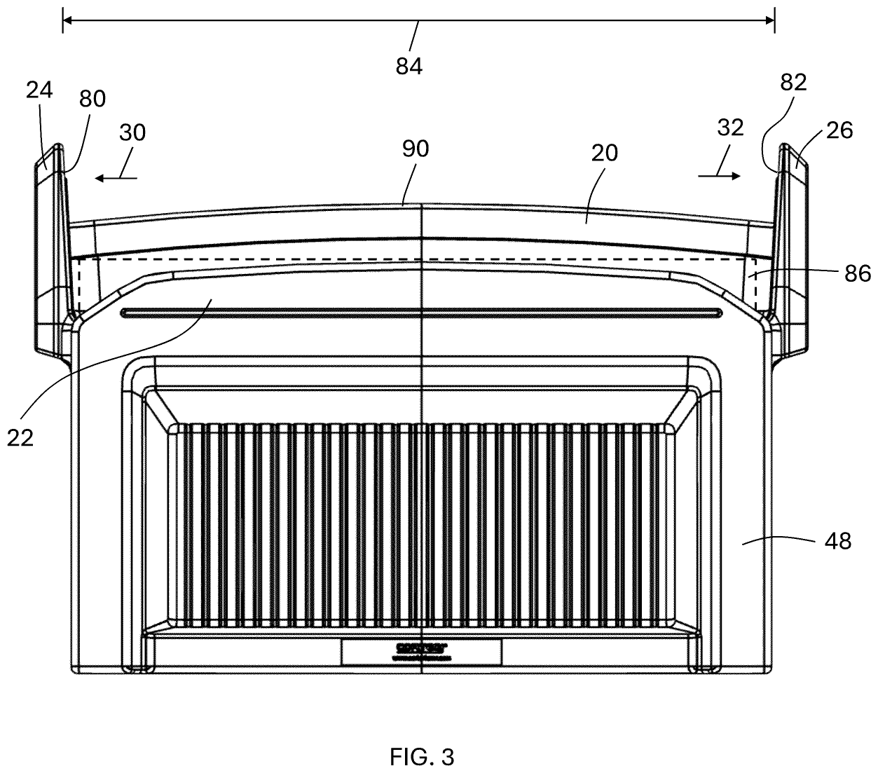

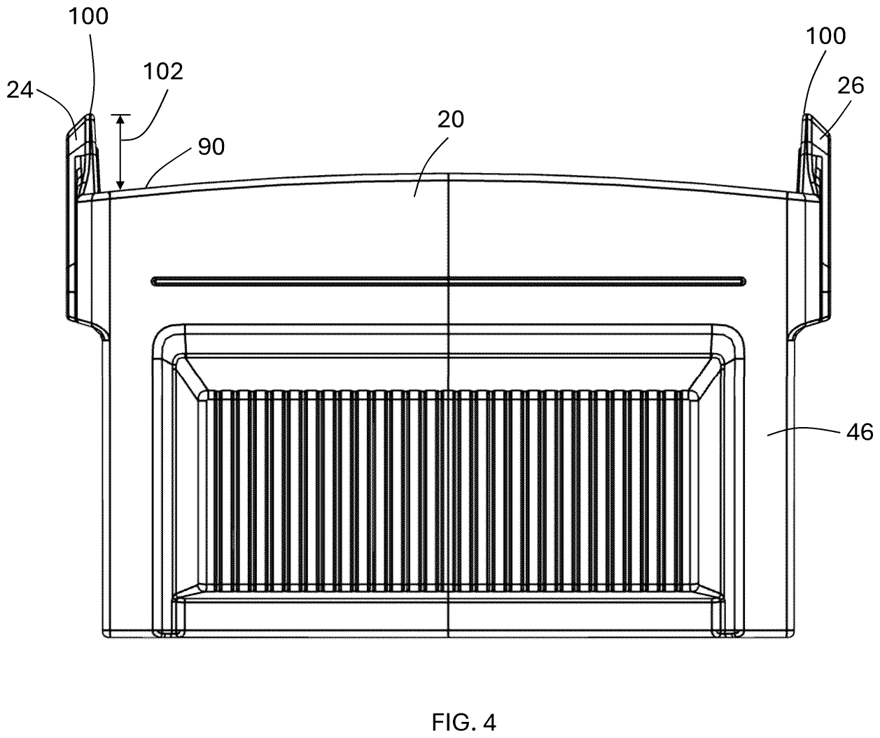

The bed 10 has a base portion 40 including opposite side walls 42, 44 (see FIGS. 1 and 2), a headboard end wall 46 (see FIG. 4), and a footboard end wall 48 (see FIG. 3). Regarding FIG. 2, the side walls 42, 44 and end walls 46, 48 each have strengthening features 50 such as beveled or inclined wall portions 60 that extend inward from post portions 62, 64, 66 and a corrugated portion 70. The corrugated portion 70 may be, for example, a series of alternating ridges and grooves.

Regarding FIG. 2, the safety rail portions 24, 26 extend upward above an upper surface 87 of the mattress 86. The safety rail portions 24, 26 have upper end portions 100 that are a distance 89 above the upper surface 87 of the mattress 86. The distance 89 may be, for example, at least two inches, at least three inches, or at least four inches as some examples.

Regarding FIG. 3, the safety rail portions 24, 26 have guard surfaces 80, 82 that a patient moving in directions 30, 32 will contact such that the guard surfaces 80, 82 stop the patient from falling off the bed 10. The guard surfaces 80, 82 are separated by a distance 84 that is sized to facilitate positioning of the mattress 86 therebetween. In one embodiment, the safety rail portions 24, 26 are taller and may extend above an upper end 90 of the headboard portion 20 as well as above an upper end 91 of the footboard portion 22. The upwardly protruding orientation of the safety rail portions 24, 26 and the headboard portion 20 provides a U-shaped receptacle for the head and shoulders of the patient that keeps the patient in place on the mattress 86.

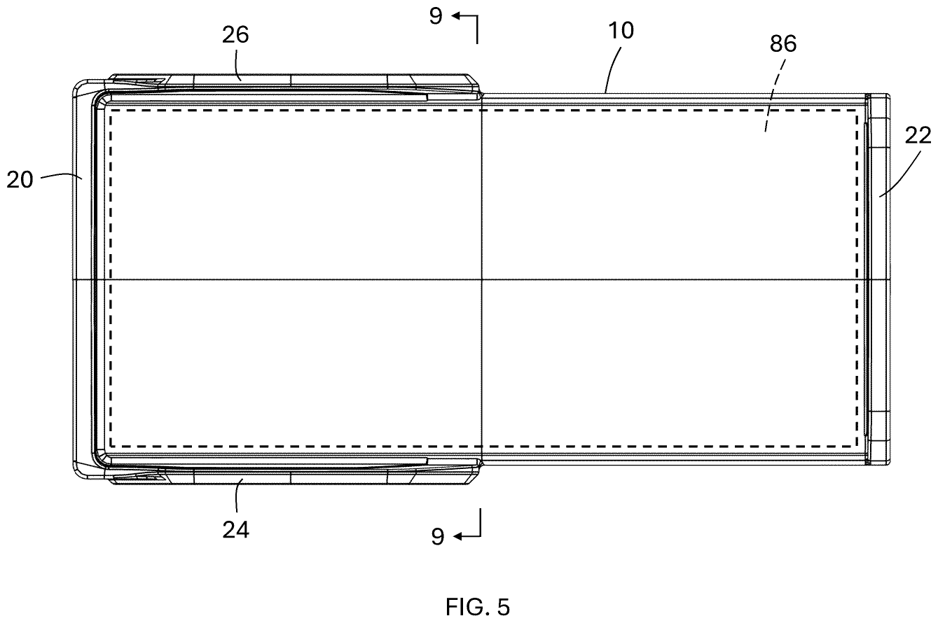

Regarding FIG. 4, the upper end portions 100 of the safety rail portions 24, 26 are a distance 102 from the upper end 90 of the headboard portion 20. The wrap-around or U-shaped orientation of the safety rail portions 24, 26 and headboard portion 20 are shown in FIG. 5. In one embodiment, the safety rail portions 24, 26 are continuous with the headboard portion 20. In other embodiments, there may be gaps between the headboard portion 20 and safety rail portions 24, 26.

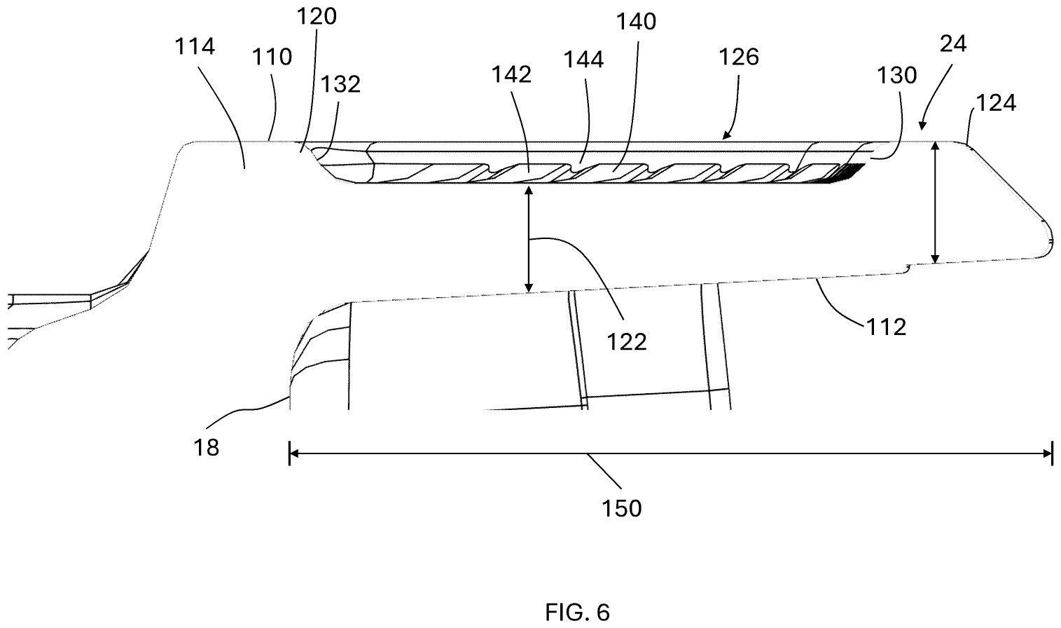

Regarding FIG. 6, the safety rail portion 24 will be described in detail. The safety rail portion 26 is similar to the safety rail portion 24. The safety rail portion 24, like the rest of the bed body 12, is formed using rotational molding and has an outer wall portion 110, an inner wall portion 112, and a void or an interior 114 therebetween. The interior 114 may be filled with air or a structural foam as desired. The safety rail portion 24 extends upward from a base portion 120 of the safety rail portion 24 and has a distance 122 between inner and outer wall portions 110, 112 that generally narrows as the safety rail portion 24 extends from the base portion 120 until reaching a beam portion 124 of the safety rail portion 24. Regarding FIG. 2, the beam portion 124 extends about a strengthening feature 126 of the safety rail 24. In one embodiment, the strengthening feature 126 includes tapered wall portions 130, 132 and a corrugated portion 140. The corrugated portion 140 is recessed and includes a series of alternating ridges 142 and grooves 144. The safety rail portion 150 has a height 150 above the mattress support surface 18 that is selected to inhibit a patient from moving laterally off the bed 10.

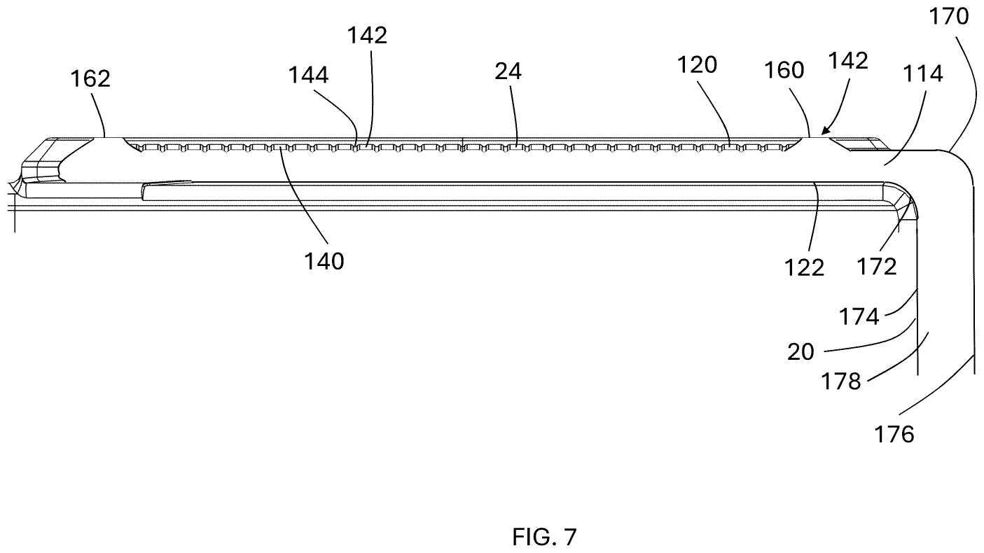

Regarding FIG. 7, the corrugated portion 140 is shown extending between sections 160, 162 of the beam portion 124. The inner and outer wall portions 120, 122 of the safety rail portion 24 are connected via junctures 170, 172 to inner and outer wall portions 174, 176 of the headboard portion 20. In this manner, the interior 126 of the beam portion 124 is continuous and is in communication with an interior 178 of the headboard portion 20, which improves the flow of material during molding of the bed body 12.

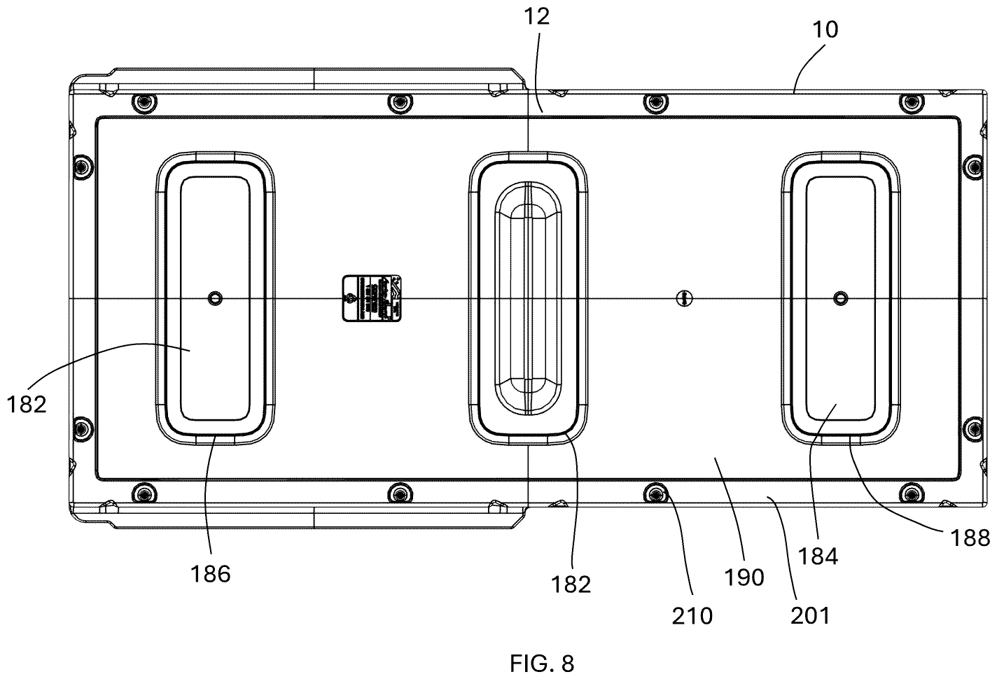

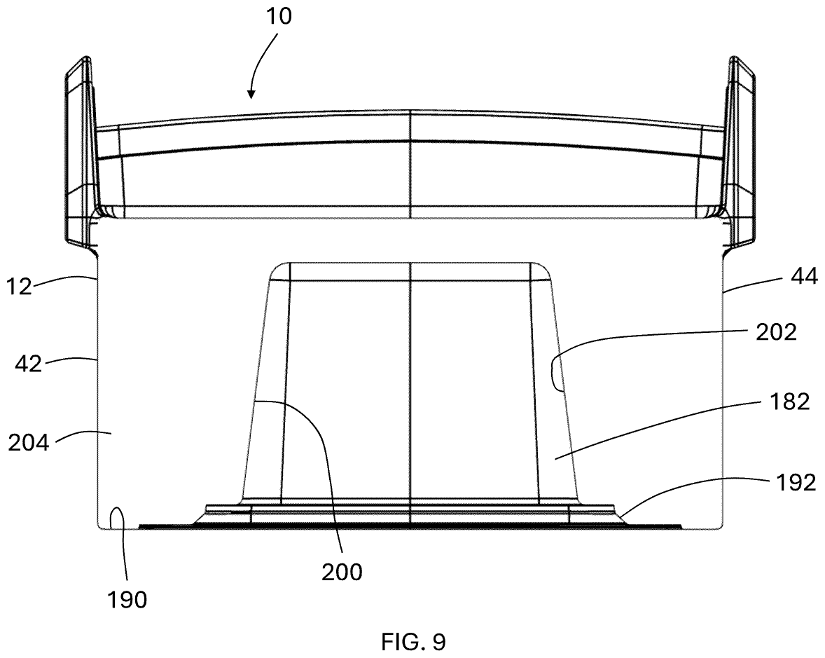

Regarding FIGS. 8 and 9, the bed 10 has a recessed portion such as a compartment 182 formed in a bottom wall 190 of the bed body 12 to strengthen the bed body 12. The bed 10 may also include one or more knockout doors 182, 184 that can be removed to form openings 186, 188 in the bottom wall 190. The knockout doors 182, 184 are connected to the bottom wall 190 via frangible portions of the bed body 12 extending about the knockout doors 182, 184. The openings 186, 188 provide access to a void or interior 204 (see FIG. 9) of the bed body 12. An installer may want to place a weighted object, such as one or more sandbags, in the interior 204 of the bed body 12 to inhibit movement of the bed 10.

Regarding FIG. 9, the compartment 182 includes an opening and walls 200, 202. The interior 204 of the bed body 12 extends between the side walls 42, 44 and walls 200, 202. The interior 204 may be filled with air or structural foam as some examples.

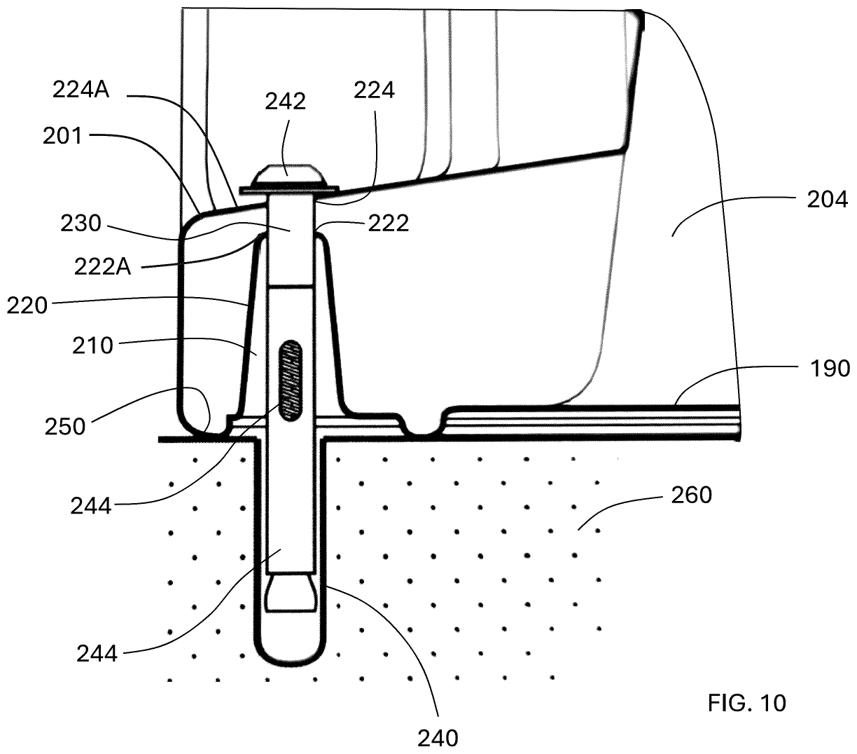

Regarding FIGS. 8 and 10, the bed body 12 has a plinth such as a mounting flange 201 with mounting holes 210 that may be formed at least in part by a frustoconical wall portion 220 of the mounting flange 201. To secure the bed 10 to a floor 260, an anchor 230 extends through openings 222, 224 in wall portions 224A, 222B of the mounting flange 210 and engages a hole 240 in the floor 260. The anchor 230 has a head 242 that may be turned using a driver to shift an actuator 244 relative to an expandable portion 245 of the anchor 230 and expand the expandable portion 245 to secure the anchor 230 in the hole 240. The bottom wall 190 of the bed 10 has an annular ridge 250 extending about the pilot hole 210 to focus the force the bed 10 applies against the floor 260 on a smaller area of the floor 260, which increases the frictional resistance to horizontal movement of the bed 10 on the floor 260. An installer may use the anchors 230 in addition to, or instead of, the sandbags in the interior 204 to secure the bed 10 in position on the floor 260.

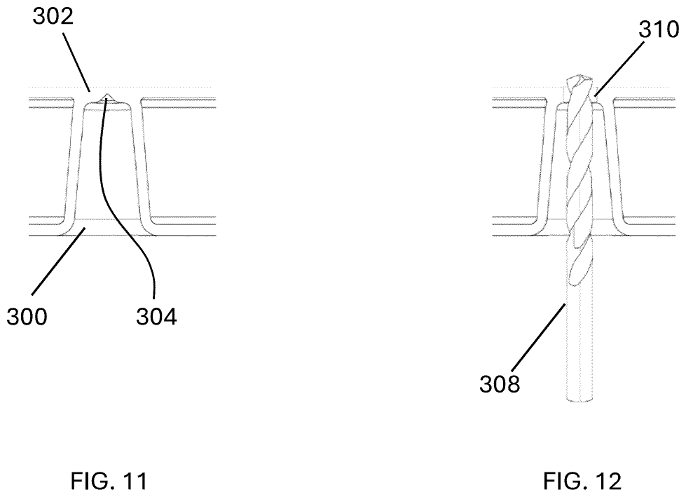

To secure the bed 10 to the floor 260 using anchors 230, an installer initially determines how many of the mounting holes 210 of the bed 10 the installer wants to use for the anchors 230. The installer next forms the openings 222, 224 in the selected mounting holes 210 of the mounting flange 201 using a process similar to the process shown in FIGS. 11 and 12.

More specifically, the mounting holes 210 initially resemble a mounting hole 300 of FIG. 11. The mounting hole 300 has a wall portion 302 closing an end of the mounting hole 300. The wall portion 302 has a recess or notch 304 for centering a drill bit 308 in the mounting hole 300. The notch 304 also reduces the thickness of the wall portion 302 which makes the wall portion 302 easier to drill through. An installer advances the drill bit 310 through the wall portion 302 to form opening 310. The openings 222, 224 of each mounting hole 210 are formed in a manner similar to opening 310 by drilling out the mounting hole 210.

Next, the installer marks the locations of the drilled-out mounting holes 210 on the floor 260 such as by extending a marker through the drilled-out mounting holes 210. The installer moves the bed 10 out of the way and drills holes 240 in the floor 260 at the marked locations.

The installer next positions the bed 10 so that the drilled-out mounting holes 210 of the mounting flange 210 are above the holes 240 in the floor 260. The installer advances the anchors 230 into the drilled-out mounting holes 210 and secures the distal ends of the anchors 230 in the holes 240 by expanding the expandable portion 245 of the anchor 230 as discussed above. In this manner, the installer secures the bed 10 to the floor 260 using the anchors 230.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept

What is claimed is:

1. A bed comprising:
a rotationally molded body, the body having a unitary, one-piece construction;
a bed pan of the body for receiving a mattress;
safety rail portions of the body on opposite sides of the bed pan, the safety rail portions configured to extend above the mattress received on the bedpan and inhibit a user from falling out of the bed.

2. The bed of claim 1 wherein the body has an overall length; and
wherein the safety rail portions each extend along the body for less than the overall length.

3. The bed of claim 1 wherein the body has a head end portion, a foot end portion, and an overall longitudinal length extending therebetween;
wherein the safety rail portions extend from the head end portion of the body toward the foot end portion of the body along the longitudinal length; and
wherein the safety rail portions each have an end spaced longitudinally from the foot end portion of the body to provide a lateral opening for ingress and egress of a user relative to the bed.

4. The bed of claim 1 wherein the body includes a headboard portion intermediate the safety rail portions, the headboard portion configured to extend above the mattress received on the bed pan.

5. The bed of claim 4 wherein the headboard portion extends from one of the safety rail portions to the other safety rail portion.

6. The bed of claim 1 wherein the body includes a headboard portion configured to extend above the mattress received on the bed pan; and
wherein the safety rail portions have upper end portions that are above an upper end portion of the headboard portion.

7. The bed of claim 1 wherein the body includes a headboard portion configured to extend above the mattress received on the bed pan; and
wherein the safety rail portions and the headboard portion form a U-shaped receptacle for a pillow and a user's head and shoulders.

8. The bed of claim 1 in combination with the mattress.

9. The bed of claim 8 wherein the mattress has a lower surface for contacting the bed pan and an upper surface opposite the lower surface; and
wherein the safety rail portions have upper end portions that are a distance of at least two inches above the upper surface of the mattress.

10. The bed of claim 1 wherein the safety rails each include a corrugated portion to strengthen the safety rail.

11. The bed of claim 1 wherein the safety rails each include an inner wall portion, an outer wall portion, and a spacing therebetween.

12. The bed of claim 1 wherein the body has a hollow interior having at least a portion thereof below the bed pan; and
wherein the safety rails each include a portion of the hollow interior.

13. The bed of claim 1 wherein the safety rails each include a beam portion extending about a strengthening feature, the strengthening feature including a series of alternating grooves and ridges.

14. The bed of claim 1 wherein the body includes a bottom portion with knockout doors that can be removed to provide access to an interior of the body.

15. The bed of claim 1 wherein the bed has a base portion with pilot holes to receive anchors for securing the base portion to a floor.

16. The bed of claim 15 wherein the base portion includes annular ridges extending about the pilot holes to engage the floor about the anchors.

17. The bed of claim 1 wherein the body has exposed outer surfaces that are ligature resistant.

18. The bed of claim 1 wherein the rotationally molded body is made of plastic.
